(19) United States
(12) Patent Application Publication
(10) Pub. No.: US 2005/0219397 A1
(43) Pub. Date: Oct. 6, 2005

(54) Automatically focusable video camera

(76) Inventor: Ming Huang Huang, Taipei (TW)

Correspondence Address: CHARLES E. BAXLEY, ESQ., 90 JOHN STREET, THIRD FLOOR, NEW YORK, NY, 10038, US

(21) Appl. No.: 10/819,522

(22) Filed: Apr. 6, 2004

(51) Int. Cl. H04N 5/225

(52) U.S. Cl. 348/335

(57) ABSTRACT

A video camera includes an optical device, and a sensitive unit disposed behind the optical device to receive and process a light transmitted through the optical device. The optical device includes four lenses disposed behind each other and equally spaced from each other for a distance d, to form an automatically focusable effect without mechanical adjusting devices. Each of the lenses may include a refraction angle for light focusing purposes. A light device may further be used to light the objects to be photographed.

### BACKGROUND OF THE INVENTION

1. Field of the Invention

The present invention relates to a video camera, and more particularly to a video camera capable of automatically focusable without mechanical adjusting devices.

2. Description of the Prior Art

As shown in FIG. 1, typical cameras or video cameras comprise an optical assembly 1 for focusing lights, and a sensitive medium 2 disposed behind the optical assembly 1 to receive the light transmitted and focused through the optical assembly 1 and to convert the light intensities and the color of images into electric current.

The typical cameras or video cameras further comprise an image processing unit 3 coupled to the sensitive medium 2, to receive and convert or process the electric current into images or image signals. The image signals may then be memorized or stored in a memory unit 4 and/or may be displayed in a display 5.

For allowing the light transmitted through the optical assembly 1 to be focused on the sensitive medium 2, as shown in FIG. 2, the optical assembly 1 includes a number sets of convex and/or concave lenses 11, 12, 13, 14 provided therein. In addition, each sets of the lenses 11-14 include a group of convex and/or concave lenses provided and arranged therein.

In addition, for adjusting the heights and/or widths of the images, one or more retractable optical assemblies 1 further required to be provided and movably coupled to the optical assembly 1 with typical mechanical adjusting devices for moving or adjusting the distances between the lenses and for focus adjusting purposes.

The typical mechanical adjusting devices may be operated or adjusted manually. For some typical cameras or video cameras, an automatic adjusting device may further be provided to automatically operate or adjust the typical mechanical adjusting devices. However, a number of parts and elements are required to be engaged into the typical cameras or video cameras which may thus include a greatly increased volume and weight.

The present invention has arisen to mitigate and/or obviate the afore-described disadvantages of the conventional video cameras.

### SUMMARY OF THE INVENTION

The primary objective of the present invention is to provide a video camera capable of automatically focusable without mechanical adjusting devices.

In accordance with one aspect of the invention, there is provided a video camera comprising an optical assembly, and a sensitive unit disposed behind the optical assembly to receive and process a light transmitted through the optical assembly. The optical assembly includes a first lens, a second lens disposed behind the first lens and spaced from the first lens for a distance d, a third lens disposed behind the second lens and spaced from the second lens for a distance d, and a fourth lens disposed behind the third lens and spaced from the third lens for a distance d, to form an automatically focusable effect without mechanical adjusting devices.

Each of the first and the second and the third and the fourth lenses includes a refraction angle formed therein for light focusing purposes. A light device may further be provided for providing a light to objects to be photographed.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram showing a typical camera or video camera;

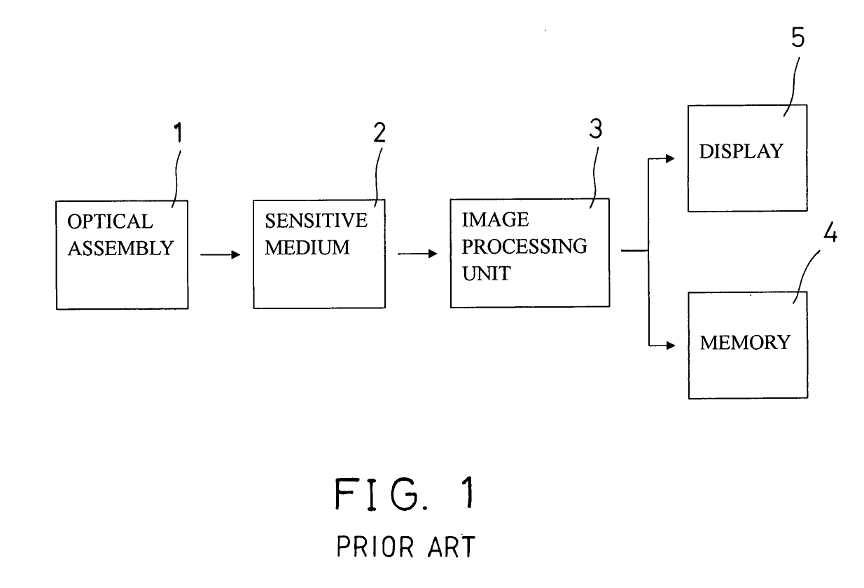

FIG. 2 is a plan schematic view illustrating an optical assembly of the typical camera or video camera;

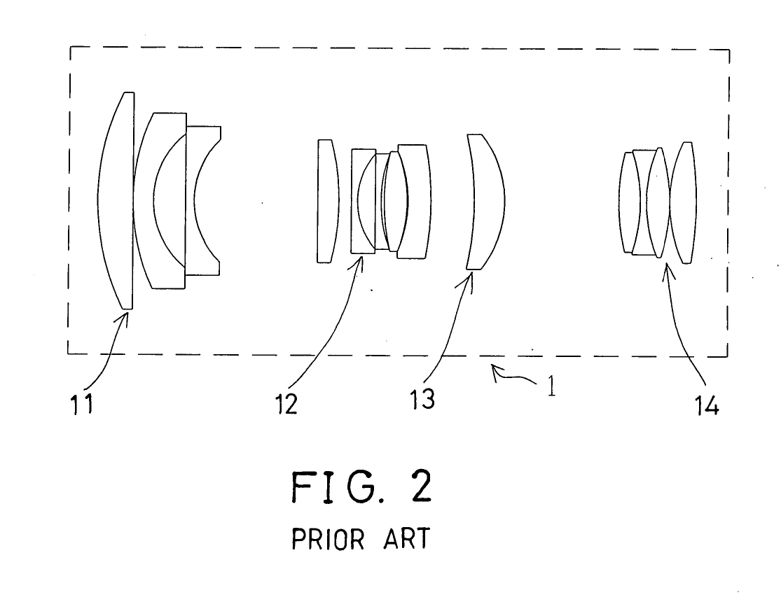

FIG. 3 is a partial exploded view of a video camera in accordance with the present invention;

FIG. 4 is a plan schematic view of an optical assembly of the video camera; and

FIG. 5 is a plan schematic view showing one lens of the optical assembly of the video camera.

### DETAILED DESCRIPTION OF THE PREFERRED EMBODIMENT

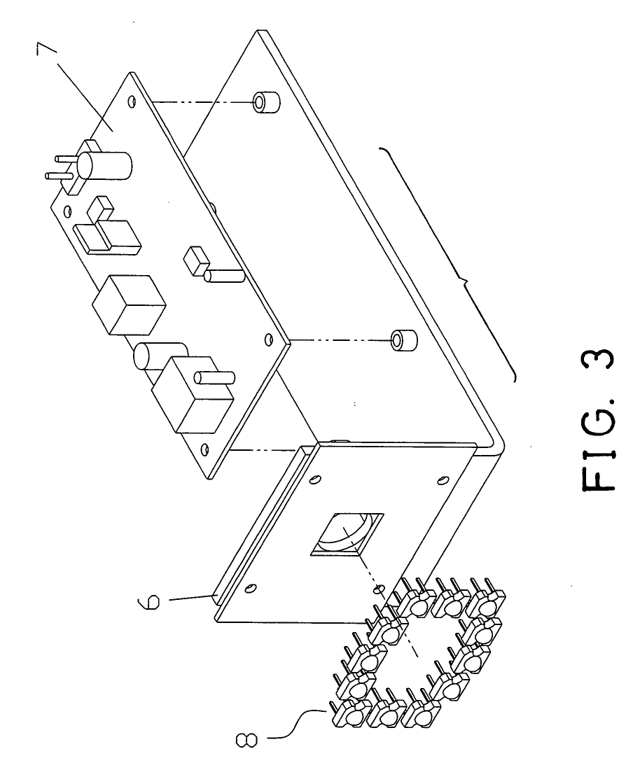

Referring to the drawings, and initially to FIG. 3, a video camera in accordance with the present invention comprises an optical assembly 6, a sensitive unit 7 disposed behind the optical assembly 6, and a lighting device 8 for lighting the objects to be photographed.

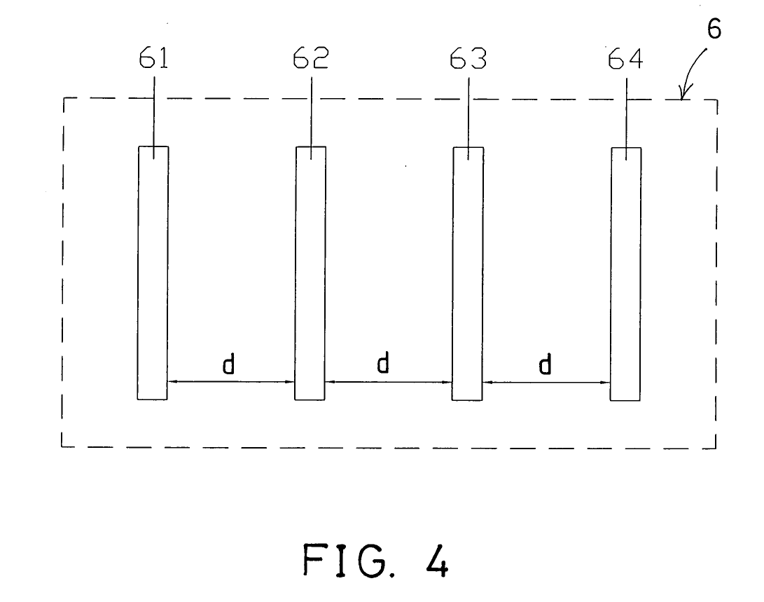

As shown in FIG. 4, the optical assembly 6 includes a first lens 61, a second lens 62 disposed behind the first lens 61 and spaced from the first lens 61 for a distance d, a third lens 63 disposed behind the second lens 62 and spaced from the second lens 62 also for a distance d, and a fourth lens 64 disposed behind the third lens 63 and spaced from the third lens 63 for a distance d.

It is to be noted that the lenses 61-64 are equally spaced away from each other for a distance d which is an effective focus. In addition, the lenses 61-64 are manufactured or formed with refraction angles to allow the lenses 61-64 of the optical assembly 6 to have the light focused on the focus, similar to the lens of human eyes, and thus to form an automatically focusable effect for the optical assembly 6.

As shown in FIG. 3, the sensitive unit 7 may be selected from charge couple device (CCD), complementary metal oxide semiconductor (CMOS), or the like, to provide the automatically focusable effect without additional mechanical adjusting devices. In operation, the lenses 61-64 of the optical assembly 6 may be used to focus the light and then to transmit the image to the sensitive unit 7. The lenses 61-64 of the optical assembly 6 may be manufactured or processed with complicated procession of coating, grinding, cleaning, and polishing, etc.

The sensitive unit 7 may receive the light transmitted and focused through the optical assembly 6 and to convert the light intensities and/or the color of images into electric current, and/or to receive and convert or process the electric current into images or image signals. The image signals may also be memorized or stored in memory units (not shown) and/or may be displayed in displays (not shown).

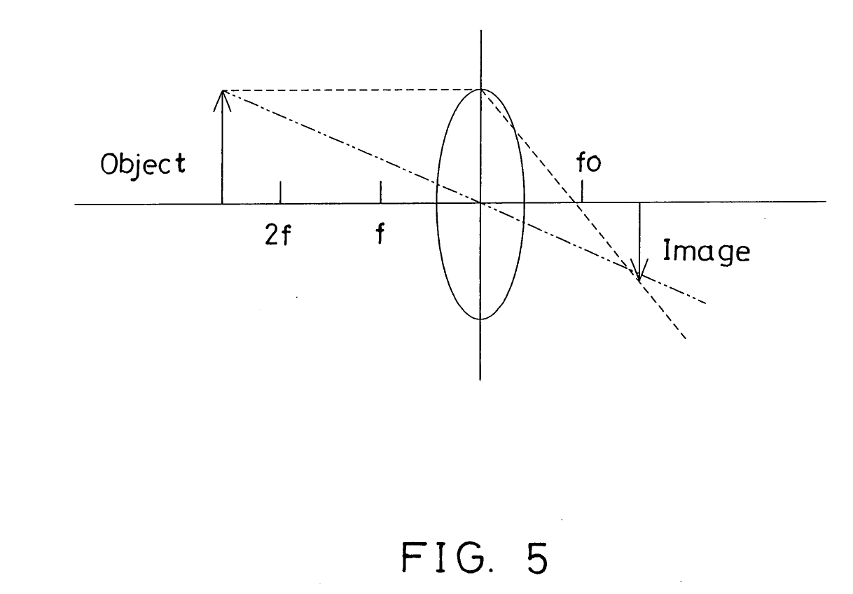

As shown in FIG. 5, illustrated is the lens formula which is based on the following equation:
1/v+1/u=1/f, wherein
f=focal length, u=object distance, and v=image distance, in which the object distance equal to image distance, and the object height equal to image height.

For example, as shown in FIG. 5:

1) If we put the object in “2f”, the image and the object are the same size.

2) If we put the object between “2f and f”, the image is magnified.

3) If we put the object in “f”, the image is at infinity.

4) When the object is closer to the lens rather than the focal length, there's only a virtual image (not a real image).

5) If we drag the object to the infinity, the image will be reduced and is shown on the “focal point”.

The lenses 61-64 of the optical assembly 6 may thus be adjusted automatically according to the environment, similar to our eyes to catch objects and to view through our visual system. Our eyes can see things clear because the cooperation of crystalline lens, retina and optic nerves. The crystalline lens can make adjustments on coming light by refraction and then transmit the message to retina so that our brain can receive the accurate messages from the optic nerves. The lenses 61-64 of the optical assembly 6 thus allow the object to be seen or caught by the sensitive unit 7 far or short.

The lighting device 8, such as light emitting diode device 8 may provide various lights, such as infrared light, to light the objects to be photographed, and for allowing the video camera in accordance with the present invention to shoot or to take images in dark environment.

It is to be noted that the video camera in accordance with the present invention is automatically focusable and includes only four lenses 61-64, instead of four groups of convex and concave lenses for the typical camera or video camera. In addition, no mechanical adjusting devices are required to adjust the distances between the lenses 61-64, such that the volume and the weight of the video camera in accordance with the present invention may be greatly decreased.

Accordingly, the video camera in accordance with the present invention is capable of automatically focusable without mechanical adjusting devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A video camera comprising:
an optical assembly, and
a sensitive unit disposed behind said optical assembly to receive and process a light transmitted through said optical assembly,
wherein said optical assembly includes a first lens, a second lens disposed behind said first lens and spaced from said first lens for a distance d, a third lens disposed behind said second lens and spaced from said second lens for a distance d, and a fourth lens disposed behind said third lens and spaced from said third lens for a distance d, to form an automatically focusable effect without mechanical adjusting devices.

2. The video camera as claimed in claim 1, wherein each of said first and said second and said third and said fourth lenses includes a refraction angle formed therein for light focusing purposes.

3. The video camera as claimed in claim 1 further comprising a light device for providing a light to objects to be photographed.
